(19) United States
(12) Patent Application Publication
(10) Pub. No.: US 2025/0377654 A1
(43) Pub. Date: Dec. 11, 2025

(54) METHODS AND SYSTEMS FOR ON-SITE INSPECTION OF UNDERGROUND SPACES BASED ON EMERGENCY SUPERVISION INTERNET OF THINGS (IOT) LARGE MODELS

(71) Applicant: CHENGDU QINCHUAN IOT TECHNOLOGY CO., LTD., Chengdu (CN)

(72) Inventors: Hanshu SHAO, Chengdu (CN); Yong LI, Chengdu (CN); Junyan ZHOU, Chengdu (CN)

(73) Assignee: CHENGDU QINCHUAN IOT TECHNOLOGY CO., LTD., Chengdu (CN)

(21) Appl. No.: 19/302,104

(22) Filed: Aug. 18, 2025

(30) Foreign Application Priority Data
Jul. 21, 2025 (CN) 202510998503.0

(51) Int. Cl. G05B 23/02; G08B 21/14

(52) U.S. Cl. CPC G05B 23/0254; G05B 23/0267; G08B 21/14; G05B 2223/06

(57) ABSTRACT

Provided are a method and a system for on-site inspection of an underground space based on an emergency supervision IoT large model. The method includes: predicting a first detection risk of each of a plurality of sub-regions to be inspected of a region to be inspected based on air monitoring information, spatial structure data, and an inspection type of the sub-region to be inspected; determining at least one machine inspection region and/or at least one manual inspection region based on the first detection risks; generating a ventilation instruction; controlling a robot to deploy a ventilation device at a target location, and controlling the ventilation device to perform ventilation; generating an inspection instruction based on the first detection risk, the air monitoring information, the spatial structure data, and the inspection type; and controlling the robot to perform an inspection.

### CROSS-REFERENCE TO RELATED APPLICATIONS

This application claims priority to Chinese Patent Application No. 202510998503.0, filed on Jul. 21, 2025, the entire contents of which are hereby incorporated by reference.

### TECHNICAL FIELD

The present disclosure relates to the field of underground space supervision, and in particular, relates to methods and systems for on-site inspection of underground spaces based on emergency supervision Internet of Things (IoT) large models.

### BACKGROUND

In the construction of a smart city, the safe management of an underground space is an important part in ensuring the stable operation of the city. Due to the accumulation of hazardous materials or insufficient oxygen in the confined urban underground space (e.g., a pipe corridor, a dark trench, an inspection well, a pipeline interior, etc.), and the complex environment, there are certain risks when an operator temporarily entering the underground space for inspection and maintenance tasks.

Currently, deploying a ventilation device in the confined urban underground space can effectively reduce the risk of poisoning and asphyxiation for the operator. Although existing IoT systems can achieve preliminary data collection and transmission, they still exhibit deficiencies in deep data analysis and intelligent decision-making. On one hand, data integration and sharing among different monitoring systems remain challenging, leading to severe information silos. On the other hand, most existing risk assessment methods rely on traditional statistical analysis, lacking the capability for in-depth data mining and real-time dynamic analysis, making it difficult to accurately identify high-risk points and key detection regions. How to analyze the risks associated with toxic gases in confined underground space before the operator conducts inspections, so as to implement safety measures in advance and prevent potential hazards, is a problem that needs to be addressed.

Therefore, it is desirable to provide a method and a system for on-site inspection of an underground space based on an emergency supervision Internet of Things (IoT) large model to realize analysis of the risks associated with toxic gases in the underground space before manual inspections, thereby enabling the implementation of preemptive safety measures for safety inspections.

### SUMMARY

One or more embodiments of the present disclosure provide a method for on-site inspection of an underground space based on an emergency supervision Internet of Things (IoT) large model, wherein the emergency supervision IoT large model includes an emergency supervision user platform, an emergency supervision service platform, an emergency supervision management platform, an emergency supervision sensor network platform, and an emergency management object platform connected in sequence, the method is executed by the emergency supervision management platform, and includes: acquiring, via the emergency supervision sensor network platform, a plurality of sub-regions to be inspected within a region to be inspected from the emergency management object platform, wherein the emergency management object platform includes at least one robot; for each of the plurality of sub-regions to be inspected, predicting a first detection risk of the sub-region to be inspected based on air monitoring information, spatial structure data, and an inspection type of the sub-region to be inspected; determining at least one machine inspection region and/or at least one manual inspection region based on first detection risks of the plurality of sub-regions to be inspected; for each of the at least one manual inspection region: generating a ventilation instruction based on the air monitoring information, the spatial structure data, and the inspection type of the manual inspection region, and sending the ventilation instruction to the emergency management object platform to: control the robot to deploy a ventilation device at a target location, and control the ventilation device to perform ventilation at a ventilation power during a ventilation period before a manual inspection; for each of the at least one machine inspection region: generating an inspection instruction based on the first detection risk, the air monitoring information, the spatial structure data, and the inspection type of the machine inspection region, and sending the inspection instruction to the emergency management object platform to: control the robot to perform an inspection within the machine inspection region along an inspection route, and perform sampling at a first sampling frequency and with a first sampling amount.

One or more embodiments of the present disclosure provide a system for on-site inspection of an underground space based on an emergency supervision Internet of Things (IoT) large model, wherein the emergency supervision IoT large model comprises an emergency supervision user platform, an emergency supervision service platform, an emergency supervision management platform, an emergency supervision sensor network platform, and an emergency management object platform connected in sequence, the emergency supervision management platform is configured to: acquire, via the emergency supervision sensor network platform, a plurality of sub-regions to be inspected within a region to be inspected from the emergency management object platform, wherein the emergency management object platform includes at least one robot; for each of the plurality of sub-regions to be inspected, predict a first detection risk of the sub-region to be inspected based on air monitoring information, spatial structure data, and an inspection type of the sub-region to be inspected; determine at least one machine inspection region and/or at least one manual inspection region based on first detection risks of the plurality of sub-regions to be inspected; for each of the at least one manual inspection region: generate a ventilation instruction based on the air monitoring information, the spatial structure data, and the inspection type of the manual inspection region, and send the ventilation instruction to the emergency management object platform to: control the robot to deploy a ventilation device at a target location, and control the ventilation device to perform ventilation at a ventilation power during a ventilation period before a manual inspection; for each of the at least one machine inspection region: generate an inspection instruction based on the first detection risk, the air monitoring information, the spatial structure data, and the inspection type of the machine inspection region, and send the inspection instruction to the emergency management object platform to: control the robot to perform an inspection within the machine inspection region along an inspection route, and perform sampling at a first sampling frequency and with a first sampling amount.

Some embodiments of the present disclosure include at least the following beneficial effects. By obtaining the sub-regions to be inspected in the region to be inspected, predicting the first detection risk of each of the sub-regions to be inspected, determining at least one machine inspection region and/or at least one manual inspection region, and then controlling the robot to perform ventilation in the at least one manual inspection region ventilation, and perform inspection and sampling in the at least one machine inspection region, it is conducive to eliminate information silos, enabling comprehensive analysis of multi-dimensional data of the region to be inspected, and improving inspection accuracy, efficiency, and safety.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numbering denotes the same structure, wherein:

FIG. 1 is a schematic diagram illustrating an exemplary system for on-site inspection of an underground space based on an emergency supervision Internet of Things (IoT) large model according to some embodiments of the present disclosure;

FIG. 2 is a flowchart illustrating an exemplary process for on-site inspection of an underground space based on an emergency supervision IoT large model according to some embodiments of the present disclosure;

FIG. 3 is a schematic diagram illustrating an exemplary effect evaluation model according to some embodiments of the present disclosure; and

FIG. 4 is a schematic diagram illustrating an exemplary inspection and sampling performed by a robot according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or”, as used herein, is merely a way of describing the associative relationship of an associated object, indicating that three relationships can exist, e.g., A and/or B, which may be represented as: An alone, both A and B, and B alone. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

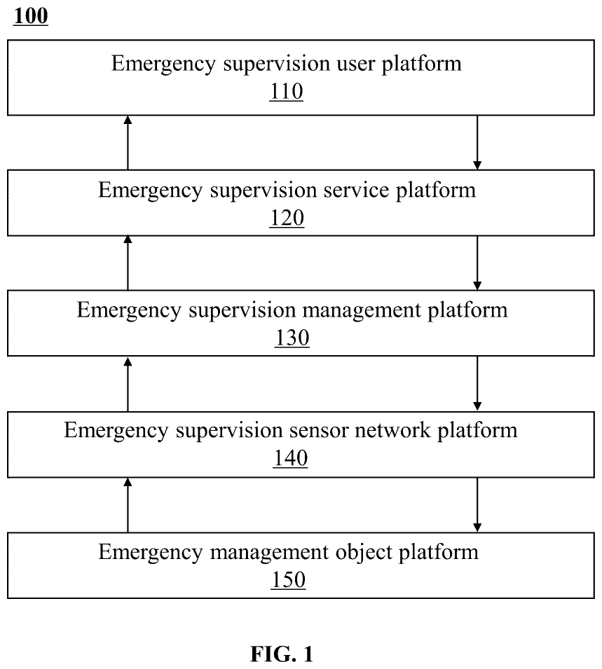

FIG. 1 is a schematic diagram illustrating an exemplary system for on-site inspection of an underground space based on an emergency supervision Internet of Things (IoT) large model according to some embodiments of the present disclosure. It should be noted that the following descriptions are intended to be exemplary and illustrative only and do not limit the scope of application of the present disclosure.

In some embodiments, as shown in FIG. 1, a system 100 for on-site inspection of an underground space based on an emergency supervision Internet of Things (IoT) large model (hereinafter referred to as the on-site inspection system 100) may include an emergency supervision user platform 110, an emergency supervision service platform 120, an emergency supervision management platform 130, an emergency supervision sensor network platform 140, and an emergency management object platform 150.

In some embodiments, information and/or data may be exchanged between one or more platforms in the system 100 for on-site inspection of the underground space over a network. In some embodiments, the network may be any one or more of a wired network or a wireless network.

The emergency supervision user platform 110 refers to a platform for interacting with a user. In some embodiments, the emergency supervision user platform 110 may be configured as a terminal device. For example, the terminal device may include a mobile phone, a tablet, or the like, or any combination thereof. In some embodiments, the emergency supervision user platform 110 may be configured to provide feedback to the user regarding air monitoring information, spatial structure data, inspection types, etc. In some embodiments, the emergency supervision user platform 110 may be further configured to receive instructions issued by the user, such as a ventilation instruction, an inspection instruction, or the like.

The emergency supervision service platform 120 refers to a platform for communicating user instructions and control information. The emergency supervision service platform 120 may interact with the emergency supervision user platform 110 and the emergency supervision management platform 130 for data exchange. For example, the emergency supervision service platform 120 may receive ventilation instructions sent by the emergency supervision user platform 110 and forward the ventilation instructions to the emergency supervision sensor network platform 140.

The emergency supervision management platform 130 refers to a platform for supervising and managing data related to the underground space on-site inspection system 100. The emergency supervision management platform 130 may interact with the emergency supervision service platform 120 and the emergency supervision sensor network platform 140 for data exchange.

In some embodiments, The emergency supervision management platform 130 may be configured to: acquire, via the emergency supervision sensor network platform 140, a plurality of sub-regions to be inspected within a region to be inspected from the emergency management object platform 150; for each of the plurality of sub-regions to be inspected, predict a first detection risk of the sub-region to be inspected based on air monitoring information, spatial structure data, and an inspection type of the sub-region to be inspected; determine at least one machine inspection region and/or at least one manual inspection region based on first detection risks of the plurality of sub-regions to be inspected; for each of the at least one manual inspection region: generate a ventilation instruction based on the air monitoring information, the spatial structure data, and the inspection type of the manual inspection region, and send the ventilation instruction to the emergency management object platform 150 to: control a robot to deploy a ventilation device at a target location, and control the ventilation device to perform ventilation at a ventilation power during a ventilation period before a manual inspection; for each of the at least one machine inspection region: generate an inspection instruction based on the first detection risk, the air monitoring information, the spatial structure data, and the inspection type of the machine inspection region, and send the inspection instruction to the emergency management object platform to: control the robot to perform an inspection within the machine inspection region along an inspection route, and perform sampling at a first sampling frequency and with a first sampling amount. More descriptions regarding the robot may be found later in the present disclosure.

In some embodiments, the emergency supervision management platform 130 is further configured to: determine the first detection risk via a risk prediction model based on the air monitoring information, the spatial structure data, and the inspection type of the sub-region to be inspected, wherein the risk prediction model is a machine learning model.

In some embodiments, the emergency supervision management platform 130 is further configured to: for each of the at least one manual inspection region: determine a protection parameter based on a third detection risk of the ventilation instruction, and send the protection parameter to the emergency management object platform 150 to: control a respirator to monitor breathing of a user based on a monitoring frequency, and control a terminal device to acquire the air monitoring information of the manual inspection region at one or more monitoring locations in the manual inspection region based on a communication frequency.

In some embodiments, the emergency supervision management platform 130 is further configured to: for each of the at least one manual inspection region: generate at least one candidate ventilation parameter based on the air monitoring information of the manual inspection region; determine a third detection risk of each of the at least one candidate ventilation parameter via an effect evaluation model based on the at least one candidate ventilation parameter, the air monitoring information of the manual inspection region, the spatial structure data, and the inspection type, and generate the ventilation instruction, wherein the effect evaluation model is a machine learning model.

In some embodiments, the emergency supervision management platform 130 is further configured to: for each of the at least one candidate ventilation parameter: in response to determining that the third detection risk of the candidate ventilation parameter is greater than a second risk threshold, optimize the candidate ventilation parameter.

In some embodiments, the emergency supervision management platform 130 is further configured to: optimize the at least one candidate ventilation parameter via a time prediction model based on a ventilation map of the manual inspection region, wherein the time prediction model is a machine learning model. More descriptions regarding the time prediction model may be found later in the present disclosure.

In some embodiments, the emergency supervision management platform 130 is further configured to: generate a comprehensive map of the region to be inspected based on ventilation maps of the plurality of sub-regions to be inspected, determine a fourth detection risk of each of edges in the comprehensive map of the region to be inspected based on the air monitoring information obtained by the robot at the plurality of issue locations, and adjust a manual inspection path within the manual inspection region.

The emergency supervision sensor network platform 140 refers to a functional platform for sensing communications. In some embodiments, the emergency supervision sensor network platform 140 may be configured as a communication network, a gateway, etc., for performing one or more of network management, protocol management, command management, and data parsing.

In some embodiments, the emergency supervision sensor network platform 140 may perform interact with the emergency supervision management platform 130 and the emergency management object platform 150 for information exchange and implement the functions of perceptual information sensing communication and control information sensing communication. For example, the emergency supervision sensor network platform 140 may receive the plurality of sub-regions to be inspected within the region to be inspected upload by the emergency management object platform 150, or send an instruction to the emergency management object platform 150 to acquire the plurality of sub-regions to be inspected within the region to be inspected. As another example, the emergency supervision sensor network platform 140 may receive an instruction for acquiring air monitoring information, spatial structure data, and an inspection type from the emergency supervision management platform 130, and upload the air monitoring information, the spatial structure data, and the inspection type to the emergency supervision management platform 130.

The emergency management object platform 150 refers to a functional platform for data collection and instructions execution. In some embodiments, the emergency management object platform 150 may include various types of devices, e.g., air monitoring devices, space scanning devices, at least one robot, or the like. For example, the air monitoring devices include a multi-gas compound detector, a single-gas detector, an air temperature and humidity sensor, or the like.

In some embodiments, the robot is equipped with at least one of a virtual reality (VR) device and an augmented reality (AR) device, and an inspection image is remotely displayed on a display device via a VR interface during the inspection, the emergency supervision management platform 130 is further configured to, for a machine inspection region where the first detection risk is greater than a first risk threshold, perform the following operations: adjusting a shooting angle of a camera within the machine inspection region via the VR device during the inspection performed by the robot, marking a plurality of issue locations on the VR interface via the AR device, and sending the plurality of issue locations to the robot, so that the robot performs sampling at the plurality of issue locations at a second sampling frequency and with a second sampling amount.

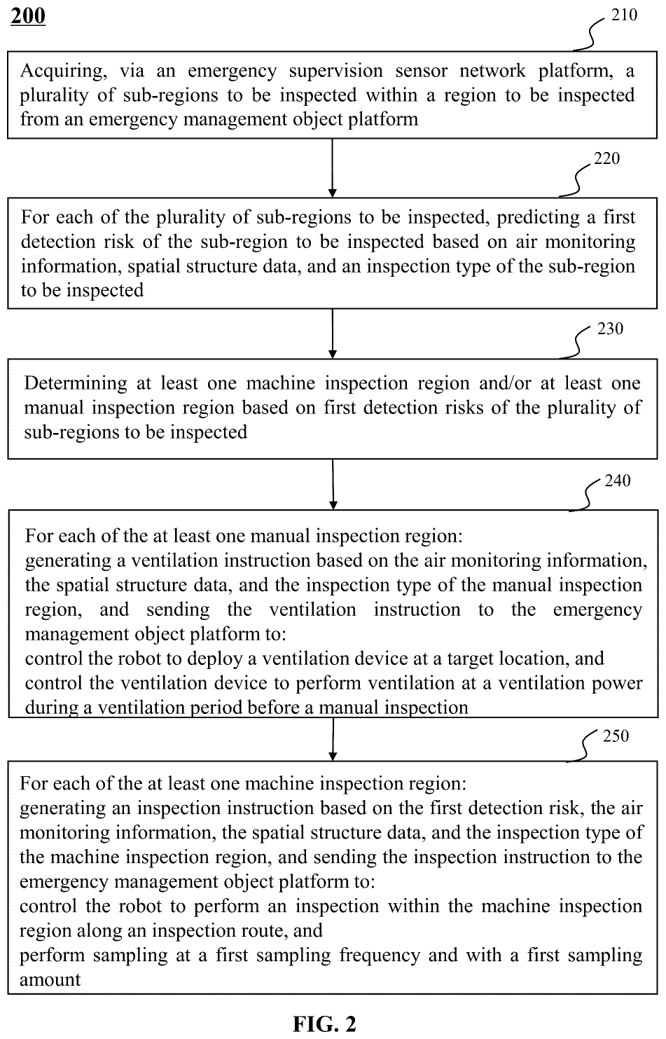

More descriptions regarding the above related platforms may be found in FIGS. 2 to 5 and the related descriptions thereof.

In some embodiments of the present disclosure, based on the on-site inspection system 100, communication connection can be realized between various functional platforms, and a closed loop of information operation among the functional platforms can be formed. The on-site inspection system 100 can run coordinately and regularly under the unified management of the emergency supervision management platform, realizing smart and information-based on-site inspection of the underground space.

It should be noted that the above descriptions of the on-site inspection system 100 are provided only for descriptive convenience, and do not limit the present disclosure to the scope of the cited embodiments.

FIG. 2 is a flowchart illustrating an exemplary process for on-site inspection of an underground space based on an emergency supervision IoT large model according to some embodiments of the present disclosure. In some embodiments, process 200 is executed by the emergency supervision management platform 130. The process 200 includes operation 210-operation 250 as follows.

In 210, via the emergency supervision sensor network platform, a plurality of sub-regions to be inspected within a region to be inspected may be acquired from the emergency management object platform.

The region to be inspected refers to an underground space waiting to be inspected. For example, the region to be inspected may be an underground space in which a gas pipeline is located. The underground space may include a pipe corridor, a dark trench, an inspection well, a pipeline interior, or the like.

In some embodiments, the emergency management object platform may acquire the region to be inspected from the emergency management object platform via the emergency supervision sensor network platform. For example, the emergency management object platform may include a geographic information system (GIS). The GIS may locate geographic positions of underground spaces and determine an underground space that has not yet been inspected in a preset time period as the region to be inspected. The GIS may send the determined region to be inspected to the emergency supervision management platform through the emergency supervision sensor network platform. The GIS may include a Global Positioning System (GPS), a BeiDou Navigation Satellite System (BDS), or the like. The preset time period refers to a preset inspection cycle for inspecting underground spaces. For example, an inspector may inspect the underground spaces every preset time period. The preset time period may be one week, one month, or the like.

A sub-region to be inspected refers to a portion of the divided region to be inspected.

In some embodiments, the emergency supervision management platform may evenly divide the region to be inspected into a plurality of sub-regions to be inspected. For example, the emergency supervision management platform may evenly divide the region to be inspected into the plurality of sub-regions to be inspected of equal size based on a total area of the region to be inspected.

In 220, for each of the plurality of sub-regions to be inspected, a first detection risk of the sub-region to be inspected may be predicted based on air monitoring information, spatial structure data, and an inspection type of the sub-region to be inspected.

The air monitoring information refers to information related to air quality. The air monitoring information may include information on the concentration of hazardous materials, information on the concentration of oxygen, or the like. The hazardous materials may include one or more of methane, hydrogen sulfide, or the like.

In some embodiments, the emergency supervision management platform may acquire the air monitoring information of the sub-region to be inspected via the emergency management object platform. For example, the emergency management object platform may include one or more monitoring devices. The emergency supervision management platform may acquire the air monitoring information via the one or more monitoring devices provided at one or more monitoring locations in the sub-region to be inspected. The one or more monitoring devices may include one or more of an electrochemical sensor, an infrared sensor, or the like.

The spatial structure data refers to three-dimensional structural data of the sub-region to be inspected. For example, if the sub-region to be inspected is a cube, the spatial structure data may include data such as a length, a width, and a height of the sub-region to be inspected.

In some embodiments, the emergency supervision management platform may acquire the spatial structure data of the sub-region to be inspected via the emergency management object platform. For example, the emergency management object platform may include one or more sensing devices. The emergency supervision management platform may acquire the spatial structure data via the one or more sensing devices provided in the sub-region to be inspected. The one or more sensing devices may include one or more of an infrared sensor, an ultrasonic sensor, or the like.

The inspection type refers to a type of an inspection operation to be performed in the underground space. For example, the inspection type may include a leak test, a pressure test, an anti-corrosion inspection, or the like.

In some embodiments, the emergency supervision management platform may determinc the inspection type based on functions or historical accident records of the gas pipeline in the underground space. For example, if the gas pipeline is a main gas transmission pipeline, the corresponding inspection type is the pressure test, the leak test, a pipeline integrity check, or the like. If the historical accident records of the gas pipeline shows that there has been an incident of gas leakage in the gas pipeline, the inspection type of sub-region to be tested may be determined as the leak test for the gas pipeline.

The first detection risk refers to a detection risk of the sub-region to be inspected before ventilation is performed, i.e., the first detection risk is an initial detection risk. The detection risk refers to a probability of the occurrence of an inspection incident.

In some embodiments, the emergency supervision management platform may predict the first detection risk of the sub-region to be inspected based on the air monitoring information, the spatial structure data, and the inspection type of the sub-region to be inspected through a cluster analysis algorithm. For example, the emergency supervision management platform may construct clustering vectors based on historical air monitoring information, historical spatial structure data, and historical inspection types of the sub-region to be inspected, and construct a target vector based on the current air monitoring information, the current spatial structure data, and the current inspection type of the sub-region to be inspected. The emergency supervision management platform may determine a plurality of clusters by clustering the clustering vectors corresponding to the sub-region to be inspected, and determine an average value by averaging cluster labels corresponding to all of the clustering vectors in the cluster containing the target vector. The average value is determined as the first detection risk corresponding to the target vector.

In some embodiments, for each of the clustering vectors, the emergency supervision management platform may determine a ratio of a count of accidents occurring in the sub-region to be inspected to a total count of historical inspections of the sub-region to be inspected under the historical conditions corresponding to the clustering vector as the cluster label of the clustering vector. The historical condition may include the historical air monitoring information, the historical spatial structure data, and the historical inspection type.

In some embodiments, the emergency supervision management platform may determine the first detection risk via a risk prediction model based on the air monitoring information, the spatial structure data, and the inspection type of the sub-region to be inspected.

The risk prediction model refers to a model configured to predict the first detection risk. In some embodiments, the risk prediction model is a machine learning model, such as a deep neural networks (DNN) model, etc.

An input of the risk prediction model may include the air monitoring information, the spatial structure data, and the inspection type of the sub-region to be inspected. An output of the risk prediction model may include the first detection risk.

In some embodiments, the risk prediction model may be obtained by training based on a large number of first training samples with first training labels. The first training samples may include sample air monitoring information, sample spatial structure data, and sample inspection types of the plurality of sub-regions to be inspected. The first training labels corresponding to the first training samples may be sample first detection risks.

The first training samples may be obtained based on historical data. The historical data may include the historical air monitoring information, the historical spatial structure data, and the historical inspection types of the plurality of sub-regions to be inspected. For each of the first training samples of a plurality sets of first training samples, the emergency supervision management platform may obtain, by querying the historical data, a count of historical accidents occurring in the sub-region to be inspected under the historical condition corresponding to the first training sample and a total count of historical inspections of the sub-region to be inspected under the historical condition corresponding to the first training sample, and determine a ratio of the count of historical accidents to the total count of historical inspections as the first training label of the training sample.

In some embodiments, the emergency supervision management platform may perform a plurality of rounds of iterative training of an initial risk prediction model based on a plurality of sets of first training samples with first training labels until an iterative condition is satisfied. The training is terminated, and the trained risk prediction model is obtained. One round of the iterative training includes: inputting a set of first training samples with the first training labels into the initial risk prediction model, constructing a value of a loss function based on the first training labels and results of the initial risk prediction model, and iteratively updating parameters of the initial risk prediction model based on the value of the loss function. The model training may be completed when the iterative condition is satisfied, and a trained risk prediction model may be obtained. The iterative condition may be that the loss function converges, a count of iterations reaches a threshold, or the value of the loss function is less than a preset function value, etc.

In some embodiments, the output of the risk prediction model may further include a second detection risk of each of one or more monitoring locations in the sub-region to be inspected.

The second detection risk refers to a detection risk of the monitoring location in the sub-region to be inspected before ventilation.

A monitoring location refers to a designated location for conducting air quality monitoring. The monitoring location may be preset. In some embodiments, the emergency supervision management platform may determine the one or more monitoring locations based on locations where historical accidents occurred, the air monitoring information of a current sub-region to be inspected, the spatial structure data, and the inspection type. For example, the emergency supervision management platform may determine a location where accidents have occurred a plurality of times in the historical data as the monitoring location, a location where the concentration of hazardous materials is high as the monitoring location, or a pipeline junction, a valve, a pressure regulating station, etc., in the sub-region to be inspected as the monitoring location.

In some embodiments, for each of the first training samples, the emergency supervision management platform may obtain, by querying the historical data, a count of historical accidents and a total count of historical inspections at the monitoring location(s) in the sub-region to be inspected corresponding to the first training sample, and determine a ratio between the count of historical accidents and the total count of historical inspections as the first training label of the first training sample.

In some embodiments of the present disclosure, using the second detection risk(s) of the monitoring location(s) within each of the sub-regions to be inspected as the output of the risk prediction model enhances the interpretability of the model with respect to the risk of the monitoring location(s), and improves the accuracy of the model in risk evaluation of the sub-regions to be inspected.

In some embodiments of the present disclosure, predicting the first detection risk by the risk prediction model can take into account the influence of multiple factors (e.g., the air monitoring information, the spatial structure data, the inspection type, etc.) on the first detection risk, which is conducive to utilizing the learning capability of the machine learning model to accurately predict the first detection risk, thereby improving inspection safety.

In 230, at least one machine inspection region and/or at least one manual inspection region may be determined based on first detection risks of the plurality of sub-regions to be inspected.

A machine inspection region refers to a sub-region to be inspected in which the robot performs an inspection.

In some embodiments, the emergency supervision management platform may determine at least one sub-region to be inspected where the first detection risks are greater than or equal to a safety threshold as the at least one machine inspection region. The safety threshold refers to a maximum first detection risk permitting inspection by the inspector. In some embodiments, the safety threshold may be preset by a technician based on prior knowledge.

A manual inspection region refers to a sub-region to be inspected in which the inspector performs an inspection.

In some embodiments, the emergency supervision management platform may determine at least one sub-region to be inspected where the first detection risks are less than the safety threshold as the at least one manual inspection region.

In 240, for each of the at least one manual inspection region, a ventilation instruction may be generated based on the air monitoring information, the spatial structure data, and the inspection type of the manual inspection region, and the ventilation instruction may be sent to the emergency management object platform to: control the robot to deploy a ventilation device at a target location, and control the ventilation device to perform ventilation at a ventilation power during a ventilation period before a manual inspection.

The ventilation instruction refers to an instruction for controlling the ventilation device to perform ventilation. The ventilation device may be a portable ventilation device (e.g., an axial fan, a centrifugal fan, etc.).

In some embodiments, the ventilation instruction may include the target location for deploying the ventilation device and the corresponding ventilation power.

The target location refers to a location for deploy the ventilation device. In some embodiments, the target location and the ventilation power may be preset by the technician based on prior knowledge.

In some embodiments, the ventilation instruction may further include a ventilation type of the ventilation device. The ventilation type of the ventilation device may be preset by the technician based on prior knowledge.

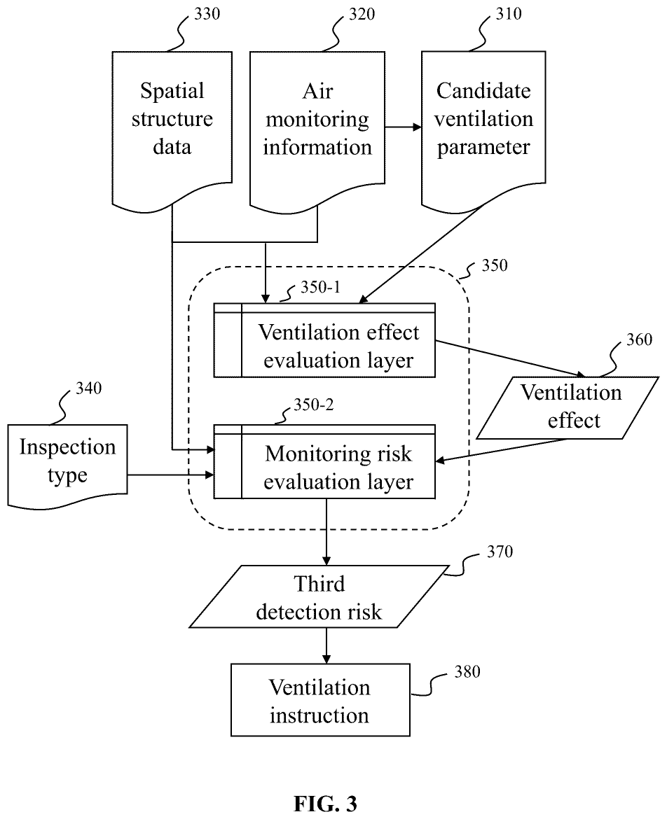

In some embodiments, the emergency supervision management platform may generate at least one candidate ventilation parameter based on the air monitoring information of the manual inspection region; determine a third detection risk of each of the at least one candidate ventilation parameter via an effect evaluation model based on the at least one candidate ventilation parameter, the air monitoring information of the manual inspection region, the spatial structure data, and the inspection type, and generate the ventilation instruction. More descriptions of this embodiment may be found in FIG. 3 and the related descriptions thereof.

The robot refers to a robot configured to perform inspection-related tasks. The robot may include an inspection robot, a transfer robot, or the like. The inspection robot refers to a robot configured to perform an inspection within the machine inspection region. The transfer robot refers to a robot configured to transfer the ventilation device.

In some embodiments, the emergency supervision management platform may send the ventilation instruction to the emergency management object platform, and the emergency management object platform may control the robot to deploy the ventilation device at the target location based on the ventilation instruction.

The manual inspection refers to an inspection process where the inspector arrives at the sub-region to be inspected to conduct inspections.

The ventilation period refers to a time period during which the ventilation device performs tasks. In some embodiments, the ventilation device may perform ventilation in the sub-region to be inspected during the ventilation period.

In some embodiments, the emergency supervision management platform may determine the ventilation period by querying a third preset table based on the third detection risk, the air monitoring information, the spatial structure data, and the inspection type. The third preset table may include a relationship between third detection risks, air monitoring information, spatial structure data, inspection types, and ventilation periods. The third preset table may be preset by the technician based on prior knowledge.

In some embodiments, the emergency supervision management platform may generate the ventilation instruction based on the target location, the ventilation power, and the ventilation period, and control the ventilation device to perform ventilation based on the ventilation instruction.

In 250, for each of the at least one machine inspection region, an inspection instruction may be generated based on the first detection risk, the air monitoring information, the spatial structure data, and the inspection type of the machine inspection region, and the inspection instruction may be sent to the emergency management object platform to: control the robot to perform an inspection within the machine inspection region along an inspection route, and perform sampling at a first sampling frequency and with a first sampling amount.

The inspection instruction refers to an instruction configured to control the robot to perform inspections. In some embodiments, the inspection instruction may include one or more inspection locations, the first sampling frequency, and the first sampling amount.

An inspection location refers to a location where the robot performs the inspection. A count of the one or more inspection locations may be set by default by the emergency supervision management platform.

In some embodiments, the emergency supervision management platform may rank the one or more monitoring locations based on the second detection risks of the one or more monitoring locations, and select one or more monitoring locations whose second detection risks are relatively high (e.g., higher than a risk threshold) as the one or more inspection locations.

The first sampling frequency refers to a frequency at which the robot collects data.

The first sampling amount refers to an amount of data that the robot is required to collect.

In some embodiments, the emergency supervision management platform may determine the first sampling frequency and the first sampling amount by querying a fourth preset table based on the first detection risk, the air monitoring information, the spatial structure data, the inspection type, and the one or more inspection locations. The fourth preset table may include a relationship between first detection risks, air monitoring information, spatial structure data, inspection types, and inspection locations, and corresponding first sampling frequencies and first sampling amounts. The fourth preset table may be preset by the technician based on requirements.

In some embodiments, the emergency supervision management platform may determine the inspection instruction based on the first sampling frequency and the first sampling amount.

The inspection route refers to a route along which the robot performs the inspection.

In some embodiments, the emergency supervision management platform may determine the inspection route of the robot based on the inspection location(s) and the spatial structure data of the sub-region to be inspected. For example, the emergency supervision management platform may determine the inspection route via a shortest-path planning algorithm based on the inspection location(s) and the spatial structure data of the sub-region to be inspected. The shortest-path planning algorithm may include a Dijkstra algorithm, a Bellman-Ford algorithm, or the like.

In some embodiments, the emergency supervision management platform may control the robot to perform inspection and sampling based on the first sampling frequency, the first sampling amount, and the inspection locations.

In some embodiments of the present disclosure, by obtaining the sub-regions to be inspected of the region to be inspected, predicting the first detection risks of the sub-regions to be inspected, determining the at least one manual inspection region and the at least one machine inspection region, and then controlling the robot to perform ventilation in the at least one manual inspection region and perform inspection and sampling in the at least one machine inspection region, it is conducive to eliminate information silos, enabling comprehensive analysis of multi-dimensional data of the region to be inspected, and improving inspection accuracy, efficiency, and safety.

In some embodiments, for each of the at least one manual inspection region, the emergency supervision management platform may monitor the inspector during the manual inspection, so as to issue a timely warning when an abnormal condition (e.g., an oxygen level below a preset threshold) is detected.

In some embodiments, for each of the at least one manual inspection region, the emergency supervision management platform may determine a protection parameter based on a third detection risk of the ventilation instruction, and send the protection parameter to the emergency management object platform to control a respirator to monitor breathing of a user based on a monitoring frequency, and control a terminal device to acquire the air monitoring information of the manual inspection region at the one or more monitoring locations in the manual inspection region based on a communication frequency.

The third detection risk refers to a detection risk of the sub-region to be inspected after the ventilation is performed.

In some embodiments, the emergency supervision management platform may acquire a ventilation effect after the ventilation is performed based on the ventilation instruction, and determine the third detection risk based on the ventilation effect, the air monitoring information, the spatial structure data, and the inspection type. For example, the emergency supervision management platform may determine the third detection risk by querying a first preset table. The first preset table may include a relationship between ventilation effects, air monitoring information, spatial structure data, inspection types, and third detection risks. The first preset table may be set by the technician based on experience, or by the emergency supervision management platform based on default setting.

In some embodiments, the emergency supervision management platform may acquire the air monitoring information after the ventilation is performed based on the ventilation instruction, and determine the ventilation effect based on the air monitoring information. For example, when the air monitoring information after performing the ventilation shows a relatively low concentration of the hazardous materials and a relatively high concentration of oxygen, it may be determined that the ventilation effect is relatively good.

The protection parameter refers to a parameter of a protection device when a user enters the region to be inspected. The user may include an inspector, technical maintenance personnel, or the like. The protection device may include a respirator, a terminal device, or the like. The terminal device may include a mobile phone, a tablet, or the like, or any combination thereof.

In some embodiments, the protection parameter may include the monitoring frequency of the respirator, the communication frequency of the terminal device, or the like.

The monitoring frequency refers to a parameter by which the respirator monitors the breathing of the user (e.g., the inspector). In some embodiments, the higher the monitoring frequency, the greater the count of breaths per unit time monitored by the respirator.

The communication frequency refers to a frequency at which the terminal device acquires the air monitoring information at the one or more monitoring locations. In some embodiments, the higher the communication frequency is, the more frequently the terminal device acquires the air monitoring information from the monitoring location(s) within a unit time.

In some embodiments, the emergency supervision management platform may determine the protection parameter by querying a second preset table based on the third detection risk. The second preset table may include a relationship between third detection risks and protection parameters (e.g., monitoring frequencies and communication frequencies). In some embodiments, the second preset table may be set by the technician based on experience, or by the emergency supervision management platform based on default setting.

In some embodiments, for each of the at least one manual inspection region, the emergency supervision management platform may acquire the third detection risk after the ventilation is performed based on the ventilation instruction, and determine the protection parameter. The emergency supervision management platform may control a respirator to monitor breathing of the user based on the monitoring frequency, and control the terminal device to acquire the air monitoring information of the manual inspection region at the one or more monitoring locations in the manual inspection region based on the communication frequency.

It should be noted that the foregoing descriptions of process 200 are intended to be exemplary and illustrative only and do not limit the scope of application of the present disclosure. For a person skilled in the art, various corrections and changes may be made to process 200 under the guidance of the present disclosure. However, these corrections and changes remain within the scope of the present disclosure.

FIG. 3 is a schematic diagram illustrating an exemplary effect evaluation model according to some embodiments of the present disclosure.

In some embodiments, as shown in FIG. 3, for each of at least one manual inspection region, an emergency supervision management platform (e.g., the emergency supervision management platform 130) may generate at least one candidate ventilation parameter 310 based on air monitoring information 320 of the manual inspection region; determine a third detection risk 370 of each of the at least one candidate ventilation parameter 310 via an effect evaluation model 350 based on the air monitoring information 320, spatial structure data 330, and an inspection type 340 of the manual inspection region, and the candidate ventilation parameter 310, and generate a ventilation instruction 380. More descriptions regarding the manual inspection region may be found elsewhere in the present disclosure (e.g., FIG. 2 and the related descriptions thereof).

The candidate ventilation parameter refers to a ventilation parameter that may be used. The ventilation parameter refers to a parameter for controlling a ventilation device to perform ventilation. The ventilation parameter may include a target location for deploying the ventilation device, a ventilation power corresponding to the ventilation device, or the like.

In some embodiments, the emergency supervision management platform may generate the at least one candidate ventilation parameter via a plurality of manners. For example, the emergency supervision management platform may determine one or more ventilation parameters that may reduce the air monitoring information (e.g., a concentration of hazardous materials, etc.) at monitoring locations in the manual inspection region to a safe state as the at least one candidate ventilation parameter. The safe state is a situation where the concentration of the hazardous materials is less than a concentration threshold. The concentration threshold may be set by a technician based on experience.

In some embodiments, for each of the at least one candidate ventilation parameter, in response to determining that the third detection risk of the candidate ventilation parameter is greater than a second risk threshold, the emergency supervision management platform may optimize the candidate ventilation parameter.

In some embodiments, the second risk threshold may be set by the technician based on experience and actual conditions.

In some embodiments, the second risk threshold may correlate to a spatial complexity of the sub-region to be inspected (e.g., the manual inspection region). The higher the spatial complexity of the sub-region to be inspected, the smaller the second risk threshold. The spatial complexity of the sub-region to be inspected refers to a parameter for measuring a structural intricacy of a spatial configuration of the sub-region to be inspected.

In some embodiments, the spatial complexity of the sub-region to be inspected may be determined based on the spatial structure data of the sub-region to be inspected. For example, the spatial complexity of the sub-region to be inspected may be determined based on a count of loops, a count of branching points, or the like in the sub-region to be inspected. Merely by way of example, the grater the count of loops and the grater the count of branching points in the sub-region to be inspected are, the lower the second risk threshold is.

In some embodiments, in response to determining that the third detection risk(s) of the at least one candidate ventilation parameter are greater than the second risk threshold, the emergency supervision management platform may select a candidate ventilation parameter with the lowest third detection risk and expand a ventilation duration corresponding to the candidate ventilation parameter until the third detection risk of the candidate ventilation parameter is less than the second risk threshold.

In some embodiments, the emergency supervision management platform may optimize the at least one candidate ventilation parameter via a time prediction model based on a ventilation map of the manual inspection region.

The ventilation map refers to a map reflects a layout and a state of ventilation in the sub-region to be inspected. The ventilation map includes nodes and edges. The nodes and the edges have attributes. The nodes may include a sensor node, a branching point node, a ventilation device node, a ventilation outlet node, or the like. The sensor node refers to a node corresponding to a location where a sensor (e.g., a pressure sensor, a chemical sensor, etc.) is deployed. An attribute of the sensor node may include the concentration of the hazardous materials. The branching point node refers to a node corresponding to a branching point of the sub-region to be inspected. The ventilation device node refers to a node corresponding to a location where the ventilation device is deployed. The ventilation outlet node refers to a node corresponding to an outlet through which air may flow out of the sub-region to be inspected. An edge refers to a connecting passage between two nodes. For example, if two nodes are located on the same passage without an intervening branching point, an edge exists between the two nodes. An attribute of the edge may be a distance between the two nodes connected by the edge.

In some embodiments, the emergency supervision management platform may determine the ventilation map based on the air monitoring information, the spatial structure data, and the at least one candidate ventilation parameter of the sub-region to be inspected.

The time prediction model refers to a model configured to determine the ventilation duration. The time prediction model is a machine learning model, such as a graph neural network (GNN) model, etc.

An input of the time prediction model may include the ventilation map of the sub-region to be inspected. An output of the time prediction model may include the ventilation duration required for the third detected risk corresponding to each of the at least one candidate ventilation parameter to be less than the second risk threshold.

In some embodiments, the time prediction model may be obtained by training based on a large number of second training samples with second training labels. A set of second training samples may include a plurality of sample ventilation maps. The second training labels corresponding to the second training samples may be actual ventilation durations required for third detection risks of sample sub-regions to be inspected to be less than the second risk threshold under the historical conditions corresponding to the second training samples.

The second training samples may be obtained based on historical data. The historical data may include historical ventilation maps determined based on historical air monitoring information, historical spatial structure data, and historical candidate ventilation parameters. For each of the second training samples, the emergency supervision management platform 130 may obtain, by querying the historical data, a sample third detection risk corresponding to the second training sample, and determine an actual ventilation required for the third detection risk to be less than the second risk threshold as the second training label.

In some embodiments, the emergency supervision management platform may perform a plurality of rounds of iterative training of an initial time prediction model based on a plurality of sets of second training samples with the second training labels until an iterative condition is satisfied. The training is terminated, and the trained time prediction model is obtained. One round of the iterative training includes: inputting a set of second training samples with second training labels into an initial time prediction model, constructing a value of a loss function based on the second training labels and results of the initial time prediction model, and iteratively updating the initial time prediction model based on the value of the loss function. The model training may be completed when the iterative condition is satisfied, and the trained time prediction model may be obtained. The iterative condition may be that the loss function converges, a count of iterations reaches a threshold, the value of the loss function is less than a preset function value, etc.

In some embodiments, the emergency supervision management platform may replace the ventilation duration in the candidate ventilation parameters with the ventilation duration output by the time prediction model to optimize the candidate ventilation parameter.

In some embodiments of the present disclosure, determining the ventilation period by the time prediction model based on the ventilation map is conducive to accurately predicting the ventilation duration of the ventilation device by utilizing the learning capability of the machine learning model, thereby ensuring a ventilation effect of the ventilation device.

In some embodiments of the present disclosure, optimizing the candidate ventilation parameter based on the third detected risk and the second risk threshold can make the ventilation device to perform ventilation based on the optimized ventilation duration, ensuring that the third detected risk is less than the second risk threshold, which is beneficial to improving the ventilation effect of the ventilation device and ensuring safe operation of the inspector.

The effect evaluation model refers to a model configured to determine the third detection risk(s) of the at least one candidate ventilation parameter. In some embodiments, the effect evaluation model is a machine learning model, such as a DNN model, etc.

In some embodiments, as shown in FIG. 3, the effect evaluation model 350 may include a ventilation effect evaluation layer 350-1 and a monitoring risk evaluation layer 350-2.

The ventilation effect evaluation layer 350-1 refers to a model configured to determine the ventilation effect of the at least one candidate ventilation parameter. In some embodiments, the ventilation effect evaluation layer is a machine learning model, such as a DNN model, etc. As shown in FIG. 3, an input of the ventilation effect evaluation layer 350-1 may include the at least one candidate ventilation parameter 310, the air monitoring information 320, and the spatial structure data 330.

In some embodiments, the ventilation effect evaluation layer may be obtained by training based on a large number of third training samples with third training labels. A set of the third training samples may include a plurality of sample candidate ventilation parameters, sample air monitoring information, and sample spatial structure data. A set of the third training labels corresponding to the set of the third training samples may be ventilation effects of the plurality of sample candidate ventilation parameters.

The third training samples may be obtained based on historical data. The historical data may include the historical candidate ventilation parameters, the historical air monitoring information, and the historical spatial structure data. For each of the third training samples, the emergency supervision management platform may ventilate the sub-region to be inspected based on the third training sample, and determine the concentration of the hazardous materials in the sub-region to be inspected after the ventilation as the third training label of the third training sample.

The training process of the ventilation effect evaluation layer is similar to the training process of the time prediction model, which is not be repeated here.

The monitoring risk evaluation layer refers to a model configured to determine the third detection risk(s) of the at least one candidate ventilation parameter. In some embodiments, the monitoring risk evaluation layer is a machine learning model, such as a DNN model, etc. As shown in FIG. 3, an input of the monitoring risk evaluation layer 350-2 may include the ventilation effect 360 of the at least one candidate ventilation parameter, the air monitoring information 320, the spatial structure data 330, and the inspection type 340.

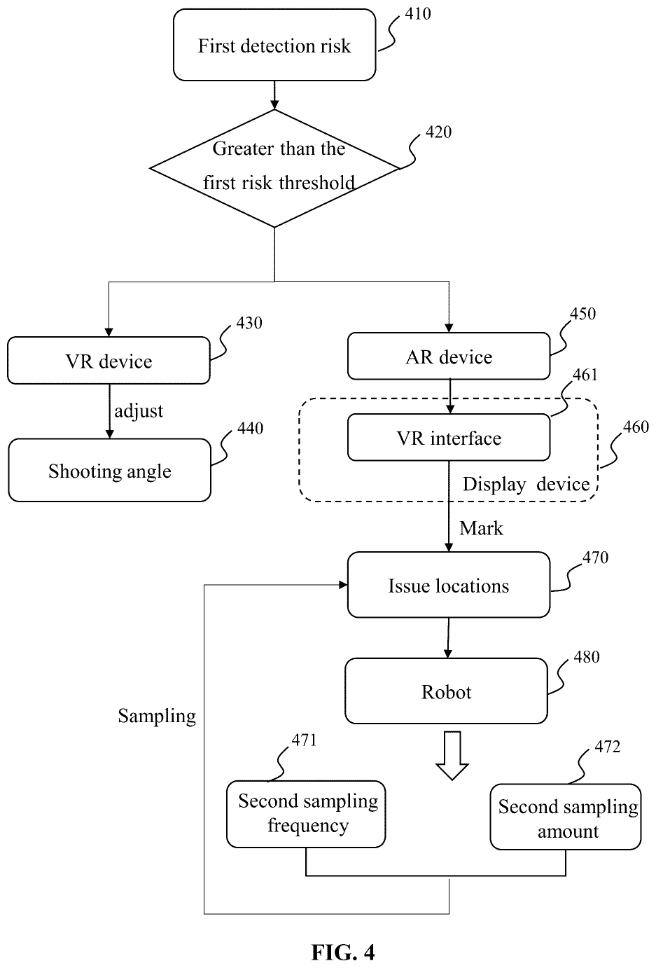

In some embodiments, the emergency supervision management platform may transfer training parameters (e.g., a loss function value, a preset function threshold, a count of iterations, etc.) of a risk prediction model to an initial monitoring risk evaluation layer. More descriptions regarding the risk prediction model may be found in FIG. 4 and the related descriptions thereof.

In some embodiments of the present disclosure, based on the at least one candidate ventilation parameters, the air monitoring information, the spatial structure data, and the inspection type, the third detection risk is determined by the effect evaluation model, which is conducive to utilizing the learning capability of the machine learning model to accurately predict the third detection risk after ventilation of the region to be inspected, thereby ensuring the ventilation effect of the ventilation device.

FIG. 4 is a schematic diagram illustrating an exemplary inspection and sampling performed by a robot according to some embodiments of the present disclosure.

In some embodiments, as shown in FIG. 4, the robot is equipped with at least one of a virtual reality (VR) device 430 and an augmented reality (AR) device 450, and an inspection image is remotely displayed on a display device 460 via a VR interface 461 during the inspection. For a machine inspection region where a first detection risk is greater than a first risk threshold, an emergency supervision management platform (e.g., the emergency supervision management platform 130) is configured to adjust a shooting angle of a camera within the machine inspection region via the VR device 430 during the inspection performed by the robot, mark a plurality of issue locations 470 on the VR interface 461 via the AR device 450, and send the plurality of issue locations 470 to the robot, so that the robot performs sampling at the plurality of issue locations 470 at a second sampling frequency 471 and with a second sampling amount 472. More descriptions regarding the first detection risk may be found elsewhere in the present disclosure (e.g., descriptions relating to operation 220 in FIG. 2). More descriptions regarding the machine inspection region may be found elsewhere in the present disclosure (e.g., descriptions relating to operation 230 in FIG. 2).

The VR device refers to a device configured to provide an immersive virtual environment. In some embodiments, the VR device may be deployed on the robot.

The AR device refers to a device configured to implement augmented reality technology. In some embodiments, the AR device may be deployed on the robot, and the AR device may further include a camera.

The VR interface refers to an interface for presenting virtualized information. In some embodiments, the VR interface may be provided on the display device. The display device refers to a device configured to display information related to the inspection. The display device may be provided on a terminal device of a user.

In some embodiments, the VR interface further includes the first detection risk and the air monitoring information of the machine inspection region in which the robot is located.

In some embodiments, the first detection risk and the air monitoring information of the machine inspection region in which the robot is located may be determined based on an average value of the first detected risks of a plurality of monitoring locations in the machine inspection region and an average value of the air monitoring information of the plurality of monitoring locations in the machine inspection region, respectively.

In some embodiments, a count of the monitoring locations in the machine inspection region in which the robot is located may be preset by a technician based on experience.

In some embodiments, the count of the monitoring locations in the machine inspection region in which the robot is located may be determined based on a count of branching points near the machine inspection region in which the robot is located. The greater the count of branching points, the greater the count of the monitoring locations for determining the first detection risk of the machine inspection region in which the robot is located.

In some embodiments of the present disclosure, displaying the first detection risk and the air monitoring information on the VR interface can help an inspector to acquire the detailed situation of the location where the inspection robot is located, thereby facilitating accurate annotation of the issue locations.

The inspection image refers to an image captured by the camera when the robot performs an inspection.

In some embodiments, the emergency supervision management platform may acquire the inspection image via the camera in the AR device.

The first risk threshold refers to a threshold condition related to the first detection risk.

In some embodiments, the first risk threshold may be preset by a technician based on requirements.

An issue location refers to a monitoring location that may pose a potential risk.

In some embodiments, the emergency supervision management platform may directly acquire the plurality of issue locations marked by the technician via the AR device based on experience.

In some embodiments, the emergency supervision management platform may send the plurality of issue locations to the robot via a network.

The second sampling frequency refers to a frequency at which the robot performs sampling at the issue locations.

The second sampling amount refers to a count samples collected by the robot at the issue locations.

In some embodiments, the second sampling frequency and the second sampling amount may be preset by the technician based on experience when marking the issue locations.

In some embodiments, the emergency supervision management platform may generate a comprehensive map of a region to be inspected based on ventilation maps of a plurality of sub-regions to be inspected, determine a fourth detection risk of each of edges in the comprehensive map of the region to be inspected based on the air monitoring information obtained by the robot at the plurality of issue locations, and adjust a manual inspection path within a manual inspection region. More descriptions regarding the region to be inspected and the sub-regions to be inspected may be found elsewhere in the present disclosure (e.g., descriptions relating to operation 210 in FIG. 2). More descriptions regarding the manual inspection region may be found elsewhere in the present disclosure (e.g., descriptions relating to operation 230 in FIG. 2).

The comprehensive map of the region to be inspected refers to a ventilation map corresponding to the region to be inspected. More descriptions regarding the ventilation map region may be found elsewhere in the present disclosure (e.g., descriptions relating to FIG. 3).

In some embodiments, the emergency supervision management platform may connect the ventilation maps of the plurality of sub-regions to be inspected to generate the comprehensive map of the region to be inspected. For example, if ventilation devices, sensors, branching points, or ventilation outlets corresponding to nodes belonging to two sub-regions to be inspected are located on the same path without intervening a branching point, the two nodes may be connected to generate an edge. In this way, the ventilation maps of the plurality of sub-regions to be inspected (including the manual inspection region and the machine inspection region) are connected to generate the comprehensive map of the region to be inspected.

The fourth detection risk of an edge in the comprehensive map refers to a detection risk (i.e., a probability of the occurrence of an inspection incident) of the edge.

In some embodiments, the emergency supervision management platform may determine a plurality of first detection risks via a risk prediction model based on the air monitoring information of the plurality of issue locations, and determine the fourth detection risk based on the plurality of first detection risks. For example, for each of the edges in the comprehensive map of the region to be inspected, the inspector may mark a plurality of issue locations on the edge via the AR device. The emergency supervision management platform may obtain a gas concentration (e.g., the concentration of hazardous materials, etc.) of each pf the plurality of issue locations corresponding to the edge through the sensors deployed at the plurality of issue locations, and input the gas concentrations to the risk prediction model to determine the first detection risks of the plurality of issue locations on the edge. The emergency supervision management platform may further determine an average value of the first detection risks of the plurality of issue locations, and determine the average value as the fourth detection risk of the edge.

The manual inspection path refers to a route for the inspector to perform inspection in the manual inspection region.

In some embodiments, the emergency supervision management platform may determine the manual inspection path based on the fourth detection risk and a third risk threshold. For example, the emergency supervision management platform may identify an edge where the fourth detection risk is greater than the third risk threshold, and edges within a predetermined range, then designate the identified edges as non-inspectable edges, and remove the non-inspectable edges from the manual inspection path.

The third risk threshold refers to a maximum allowable value of the fourth detection risk for maintaining safety compliance. In some embodiments, the third risk threshold may be preset by the technician based on experience.

The predetermined range refers to a range within which manual inspections are prohibited. For example, the predetermined range may include edges within a preset distance from an edge where the fourth detection risk is greater than the third risk threshold. For example, if the fourth detection risk of an edge M is greater than the third risk threshold, and the edge M connects nodes K and P, where the node K is connected to edges K1, K2, K3, and the node P is connected to edges P1, P2, P3, then the edges K1, K2, K3, P1, P2, and P3 are at a distance of 1 from the edge M. If K1 connects nodes K and O, and the node O is connected to edges O1, O2, and O3, then the distance between M and each of O1, O2, and O3 is 2. If the preset distance is 1, then the predetermined range may include edges M, K1, K2, K3, P1, P2, P3, and the edges included in the predetermined range may be removed from the manual inspection path.

In some embodiments, the preset distance may be set by the technician based on experience. The preset distance may be related to the fourth detection risk. The greater the fourth detection risk is, the larger the preset distance is.

In some embodiments of the present disclosure, the manual inspection path can be dynamically adjusted in real time based on the data collected by the inspection robot, thereby ensuring that the manual inspection path avoids hazardous regions, preventing accidents and injuries during inspection, and ensuring the personal safety of the inspector.

In some embodiments of the present disclosure, the shooting angle of the camera within the region to be inspected is adjusted via the VR device, a plurality of issue locations are marked on the VR interface via the AR device, and then the plurality of issue locations are sent to the robot, so that the robot performs sampling at the plurality of issue locations, which enables the inspector to remotely monitor the inspection of the robot, thereby improving the interaction effect of the inspector and the inspection efficiency, and the remote monitoring manner is further conducive to ensuring the safety of the inspector.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Furthermore, the recited order of processing elements or sequences, or the use of numbers, letters, or other designations thereof, are not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by +20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A system for on-site inspection of an underground space based on an emergency supervision Internet of Things (IoT) large model, wherein the emergency supervision IoT large model comprises an emergency supervision user platform, an emergency supervision service platform, an emergency supervision management platform, an emergency supervision sensor network platform, and an emergency management object platform connected in sequence,
the emergency supervision management platform is configured to:
acquire, via the emergency supervision sensor network platform, a plurality of sub-regions to be inspected within a region to be inspected from the emergency management object platform, wherein the emergency management object platform includes at least one robot;
for each of the plurality of sub-regions to be inspected, predict a first detection risk of the sub-region to be inspected based on air monitoring information, spatial structure data, and an inspection type of the sub-region to be inspected;
determine at least one machine inspection region and/or at least one manual inspection region based on first detection risks of the plurality of sub-regions to be inspected;
for each of the at least one manual inspection region:
generate a ventilation instruction based on the air monitoring information, the spatial structure data, and the inspection type of the manual inspection region, and
send the ventilation instruction to the emergency management object platform to:
control the robot to deploy a ventilation device at a target location, and
control the ventilation device to perform ventilation at a ventilation power during a ventilation period before a manual inspection;
for each of the at least one machine inspection region:
generate an inspection instruction based on the first detection risk, the air monitoring information, the spatial structure data, and the inspection type of the machine inspection region, and send the inspection instruction to the emergency management object platform to:
control the robot to perform an inspection within the machine inspection region along an inspection route, and
perform sampling at a first sampling frequency and with a first sampling amount.

2. The system of claim 1, wherein the emergency supervision management platform is further configured to:
determine the first detection risk via a risk prediction model based on the air monitoring information, the spatial structure data, and the inspection type of the sub-region to be inspected, wherein the risk prediction model is a machine learning model.

3. The system of claim 2, wherein an output of the risk prediction model includes a second detection risk of each of one or more monitoring locations in the sub-region to be inspected, wherein the one or more monitoring locations are configured with one or more monitoring devices for acquiring the air monitoring information.

4. The system of claim 1, wherein the emergency supervision management platform is further configured to:
for each of the at least one manual inspection region:
determine a protection parameter based on a third detection risk of the ventilation instruction, and send the protection parameter to the emergency management object platform to:
control a respirator to monitor breathing of a user based on a monitoring frequency, and
control a terminal device to acquire the air monitoring information of the manual inspection region at one or more monitoring locations in the manual inspection region based on a communication frequency.

5. The system of claim 1, wherein the emergency supervision management platform is further configured to:
for each of the at least one manual inspection region:
generate at least one candidate ventilation parameter based on the air monitoring information of the manual inspection region;
determine a third detection risk of each of the at least one candidate ventilation parameter via an effect evaluation model based on the at least one candidate ventilation parameter, the air monitoring information of the manual inspection region, the spatial structure data, and the inspection type, and generate the ventilation instruction, wherein the effect evaluation model is a machine learning model.

6. The system of claim 5, wherein the emergency supervision management platform is further configured to:
for each of the at least one candidate ventilation parameter:
in response to determining that the third detection risk of the candidate ventilation parameter is greater than a second risk threshold, optimize the candidate ventilation parameter.

7. The system of claim 6, wherein the emergency supervision management platform is further configured to:
optimize the at least one candidate ventilation parameter via a time prediction model based on a ventilation map of the manual inspection region, wherein the time prediction model is a machine learning model.

8. The system of claim 1, wherein the robot is equipped with at least one of a virtual reality (VR) device and an augmented reality (AR) device, and an inspection image is remotely displayed on a display device via a VR interface during the inspection,
the emergency supervision management platform is further configured to:
for a machine inspection region where the first detection risk is greater than a first risk threshold:
adjust a shooting angle of a camera within the machine inspection region via the VR device during the inspection performed by the robot; and
mark a plurality of issue locations on the VR interface via the AR device, and send the plurality of issue locations to the robot, so that the robot performs sampling at the plurality of issue locations at a second sampling frequency and with a second sampling amount.

9. The system of claim 8, wherein the VR interface further includes the first detection risk and the air monitoring information of the machine inspection region in which the robot is located.

10. The system of claim 8, wherein the emergency supervision management platform is further configured to:
generate a comprehensive map of the region to be inspected based on ventilation maps of the plurality of sub-regions to be inspected; and
determine a fourth detection risk of each of edges in the comprehensive map of the region to be inspected based on the air monitoring information obtained by the robot at the plurality of issue locations, and adjust a manual inspection path within the manual inspection region.

11. A method for on-site inspection of an underground space based on an emergency supervision Internet of Things (IoT) large model, wherein the emergency supervision IoT large model comprises an emergency supervision user platform, an emergency supervision service platform, an emergency supervision management platform, an emergency supervision sensor network platform, and an emergency management object platform connected in sequence,
the method is executed by the emergency supervision management platform, and comprises:
acquiring, via the emergency supervision sensor network platform, a plurality of sub-regions to be inspected within a region to be inspected from the emergency management object platform, wherein the emergency management object platform includes at least one robot;
for each of the plurality of sub-regions to be inspected, predicting a first detection risk of the sub-region to be inspected based on air monitoring information, spatial structure data, and an inspection type of the sub-region to be inspected;
determining at least one machine inspection region and/or at least one manual inspection region based on first detection risks of the plurality of sub-regions to be inspected;
for each of the at least one manual inspection region:
generating a ventilation instruction based on the air monitoring information, the spatial structure data, and the inspection type of the manual inspection region, and sending the ventilation instruction to the emergency management object platform to:
control the robot to deploy a ventilation device at a target location, and
control the ventilation device to perform ventilation at a ventilation power during a ventilation period before a manual inspection;
for each of the at least one machine inspection region:
generating an inspection instruction based on the first detection risk, the air monitoring information, the spatial structure data, and the inspection type of the machine inspection region, and sending the inspection instruction to the emergency management object platform to:
control the robot to perform an inspection within the machine inspection region along an inspection route, and
perform sampling at a first sampling frequency and with a first sampling amount.

12. The method of claim 11, wherein the predicting a first detection risk of the sub-region to be inspected based on air monitoring information, spatial structure data, and an inspection type of the sub-region to be inspected includes:
determining the first detection risk via a risk prediction model based on the air monitoring information, the spatial structure data, and the inspection type of the sub-region to be inspected, wherein the risk prediction model is a machine learning model.

13. The method of claim 12, wherein an output of the risk prediction model includes a second detection risk of each of one or more monitoring locations in the sub-region to be inspected, wherein the one or more monitoring locations are configured with one or more monitoring devices for acquiring the air monitoring information.

14. The method of claim 11, further comprising:
for each of the at least one manual inspection region:
determining a protection parameter based on a third detection risk of the ventilation instruction, and sending the protection parameter to the emergency management object platform to:
control a respirator to monitor breathing of a user based on a monitoring frequency, and
control a terminal device to acquire the air monitoring information of the manual inspection region at one or more monitoring locations in the manual inspection region based on a communication frequency.

15. The method of claim 11, further comprising:
for each of the at least one manual inspection region:
generating at least one candidate ventilation parameter based on the air monitoring information of the manual inspection region;
determining a third detection risk of each of the at least one candidate ventilation parameter via an effect evaluation model based on the at least one candidate ventilation parameter, the air monitoring information of the manual inspection region, the spatial structure data, and the inspection type, and generating the ventilation instruction, wherein the effect evaluation model is a machine learning model.

16. The method of claim 15, further comprising:
for each of the at least one candidate ventilation parameter:
in response to determining that the third detection risk of the candidate ventilation parameter is greater than a second risk threshold, optimizing the candidate ventilation parameter.

17. The method of claim 16, further comprising:
optimizing the at least one candidate ventilation parameter via a time prediction model based on a ventilation map of the manual inspection region, wherein the time prediction model is a machine learning model.

18. The method of claim 11, wherein the robot is equipped with at least one of a virtual reality (VR) device and an augmented reality (AR) device, and an inspection image is remotely displayed on a display device via a VR interface during the inspection,
the method further comprising:
for a machine inspection region where the first detection risk is greater than a first risk threshold:
adjusting a shooting angle of a camera within the machine inspection region via the VR device during the inspection performed by the robot; and
marking a plurality of issue locations on the VR interface via the AR device, and sending the plurality of issue locations to the robot, so that the robot performs sampling at the plurality of issue locations at a second sampling frequency and with a second sampling amount.

19. The method of claim 18, wherein the VR interface further includes the first detection risk and the air monitoring information of the machine inspection region in which the robot is located.

20. The method of claim 18, further comprising:
generating a comprehensive map of the region to be inspected based on ventilation maps of the plurality of sub-regions to be inspected; and
determining a fourth detection risk of each of edges in the comprehensive map of the region to be inspected based on the air monitoring information obtained by the robot at the plurality of issue locations, and adjusting a manual inspection path within the manual inspection region.
